(19) United States
(12) Patent Application Publication
(10) Pub. No.: US 2025/0323283 A1
(43) Pub. Date: Oct. 16, 2025

(54) PHOSPHATE-TOLERANT CORE-SHELL CATALYSTS NANOPARTICLES FOR HIGH TEMPERATURE FUEL CELLS AND FUEL CELLS WITH THE SAME

(71) Applicant: Toyota Motor Engineering & Manufacturing North America, Inc., Plano, TX (US)

(72) Inventors: Honghong Lin, Ann Arbor, MI (US); Liang Wang, Ann Arbor, MI (US); Gaohua Zhu, Ann Arbor, MI (US); Siwen Wang, Ann Arbor, MI (US); Chen Ling, Troy, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/636,821

(22) Filed: Apr. 16, 2024

(51) Int. Cl. H01M 4/90; H01M 4/86; H01M 8/10; H01M 8/1213

(52) U.S. Cl. CPC H01M 4/9058; H01M 4/8663; H01M 8/1213; H01M 2008/1095

(57) ABSTRACT

A high temperature fuel cell includes an anode, a cathode, a polymer electrolyte membrane disposed between the anode and the cathode, phosphoric acid, and a cathode catalyst disposed on the cathode and in contact with the phosphoric acid. The cathode catalyst includes a Pd-containing core or a Pt-containing core, a Pt-containing shell, in a compressed state, on the Pd-containing core, and an anti-phosphate poisoning surface modifier disposed on the Pt-containing shell.

### TECHNICAL FIELD

The present disclosure generally relates to catalysts, and particularly to catalysts for high temperature fuel cells.

### BACKGROUND

Fuel cells with polymer electrolyte membranes (PEMs) are used as energy sources for transportation due to their high-power density, low operation temperatures, and zero emission of harmful gases. However, electrolytes used in PEM fuel cells can include one or more components that poison anode and/or cathode catalyst materials of a PEM fuel cell and thereby reduce the power output and efficiency thereof. For example, high temperature PEM (HT-PEM) fuel cells with phosphoric acid electrolytes are subject to phosphate poisoning of cathode catalysts materials.

The present disclosure addresses the issue of poisoning of anode and/or cathode catalyst materials of PEM fuel cells, and other issues related to HT-PEM fuel cells.

### SUMMARY

In one form of the present disclosure, a high temperature fuel cell includes an anode, a cathode, a polymer electrolyte membrane disposed between the anode and the cathode, a phosphoric acid electrolyte, and a cathode catalyst disposed on the cathode and in contact with the phosphoric acid electrolyte. The cathode catalyst includes a core selected form a Pd-containing core or a Pt-containing core, a Pt-containing shell, in a compressed state, on the core, and an anti-phosphate poisoning surface modifier disposed on the Pt-containing shell.

In another form of the present disclosure, a high temperature fuel cell includes an anode, a cathode, a polymer electrolyte membrane disposed between the anode and the cathode, a phosphoric acid electrolyte, and a cathode nanoparticle catalyst disposed on the cathode and in contact with the phosphoric acid electrolyte. The cathode nanoparticle catalyst includes a plurality of nanoparticles with a Pd alloy core, a Pt alloy shell, in a compressed state, on the Pd-containing core, and an anti-phosphate poisoning surface modifier disposed on the Pt alloy shell.

In still another form of the present disclosure, a high temperature fuel cell includes an anode, a cathode, a polymer electrolyte membrane disposed between the anode and the cathode, a phosphoric acid electrolyte, and a cathode nanoparticle catalyst disposed on the cathode and in contact with the phosphoric acid electrolyte. The cathode nanoparticle catalyst includes a plurality of nanoparticles with a Pt alloy core having a diameter between about 3 nm and about 20 nm, a Pt alloy shell, in a compressed state, having a thickness less than about 2 nm on the Pt alloy core, and an anti-phosphate poisoning surface modifier disposed on the Pt alloy shell.

These and other features of the fuel cells will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is a graphical plot of binding energy of adsorbed species OH*, OOH*, and HPO₄]²⁻ as a function of compressive strain of a Pt containing shell according to the teachings of the present disclosure;

FIG. 2A illustrates a high temperature PEM fuel cell according to the teachings of the present disclosure;

FIG. 2B illustrates an enlarged view of an interface section labeled 2B in FIG. 2A;

FIG. 2C illustrates an enlarged view of a carbon support particle loaded with phosphate-tolerant core-shell nanoparticles according to the teachings of the present disclosure at the interface in FIG. 2B;

FIG. 2D illustrates an enlarged cross-section of a phosphate-tolerant core-shell nanoparticle according to the teachings of the present disclosure;

FIG. 3A is a graphical plot of cyclic voltammetry of a Pt nanoparticle on a carbon support catalyst (labeled “Pt/C”) without an anti-phosphate poisoning surface modifier and a Pt/C nanoparticle catalyst with an anti-phosphate poisoning surface modifier (labeled “Modified-Pt/C) in argon (Ar)-saturated 0.1 M HClO₄;

FIG. 3B is a graphical plot of electrochemical surface area of the Pt/C nanoparticle catalyst without an anti-phosphate poisoning surface modifier and the Pt/C nanoparticle catalyst with an anti-phosphate poisoning surface modifier in the Ar-saturated 0.1 M HClO₄;

FIG. 4A is a graphical plot of cyclic voltammetry of a Pt/C nanoparticle catalyst without an anti-phosphate poisoning surface modifier and a Pt/C nanoparticle catalyst with an anti-phosphate poisoning surface modifier in Ar-saturated 0.1 M HClO₄+0.1 M H₃PO₄;

FIG. 4B is a graphical plot of electrochemical surface area of the Pt/C catalyst without an anti-phosphate poisoning surface modifier and the Pt/C nanoparticle catalyst with an anti-phosphate poisoning surface modifier in the Ar-saturated 0.1 M HClO₄+0.1 M H₃PO₄;

FIG. 5A is a graphical plot of linear scanning voltammetry of a Pt/C nanoparticle catalyst without an anti-phosphate poisoning surface modifier and a Pt/C nanoparticle catalyst with an anti-phosphate poisoning surface modifier in oxygen (O₂)-saturated 0.1 M HClO₄;

FIG. 5B is a graphical plot of mass activity of the Pt/C nanoparticle catalyst without an anti-phosphate poisoning surface modifier and the Pt/C nanoparticle catalyst with an anti-phosphate poisoning surface modifier in the O₂-saturated 0.1 M HClO₄;

FIG. 5C is a graphical plot of specific activity of the Pt/C nanoparticle catalyst without an anti-phosphate poisoning surface modifier and the Pt/C nanoparticle catalyst with an anti-phosphate poisoning surface modifier in the O₂-saturated 0.1 M HClO₄;

FIG. 6A is a graphical plot of linear scanning voltammetry of a Pt/C nanoparticle catalyst without an anti-phosphate poisoning surface modifier and a Pt/C nanoparticle catalyst with an anti-phosphate poisoning surface modifier in O₂-saturated 0.1 M HClO₄+0.1 M H₃PO₄;

FIG. 6B is a graphical plot of mass activity of the Pt/C nanoparticle catalyst without an anti-phosphate poisoning surface modifier and the Pt/C nanoparticle catalyst with an anti-phosphate poisoning surface modifier in the O₂-saturated 0.1 M HClO₄+0.1 M H₃PO₄;

FIG. 6C is a graphical plot of specific activity of the Pt/C nanoparticle catalyst without an anti-phosphate poisoning surface modifier and the Pt/C nanoparticle catalyst with an anti-phosphate poisoning surface modifier in the O₂-saturated 0.1 M HClO₄+0.1 M H₃PO₄;

FIG. 7A is a graphical plot of the difference between the linear scanning voltammetry of the Pt/C nanoparticle catalyst, with and without an anti-phosphate poisoning surface modifier, in Ar-saturated 0.1 M HClO₄ (reference) and in Ar-saturated 0.1 M HClO₄+0.1 M H₃PO₄; and

FIG. 7B is a graphical plot of oxygen adsorption, in percent retention, for the Pt/C nanoparticle catalyst without an anti-phosphate poisoning surface modifier and the Pt/C nanoparticle catalyst with an anti-phosphate poisoning surface modifier.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

Phosphoric acid poisoning of platinum (Pt) containing (Pt-containing) catalysts suppresses the activity of the oxygen reduction reaction (ORR) in HT-PEM fuel cells operating at temperatures between about 80° C. and about 230° C.). Not being bound by theory, the poisoning is due to adsorption of phosphate on the platinum surface of such catalysts, which decreases the surface reactive site number. And while it is known that bimetallic catalysts “PtM” (e.g., where M=Fe, Co, Ni, etc.) improve the ORR activity in low temperature PEM (LT-PEM) fuel cells that operate at temperatures between about 60° C. and about 80° C. via optimizing the Pt—O binding strength on the platinum surface to facilitate the ORR kinetics, the high ORR activity cannot be translated from LT-PEM fuel cells to HT-PEM fuel cells since the presence of phosphoric acid in HT-PEM fuel cells suppresses the ORR activity via phosphoric acid adsorption. Stated differently, Pt-containing catalysts known to be effective in LT-PEM fuel cells are known not to be effective in HT-PEM fuel cells.

In view of the above, the present disclosure provides an electrode catalyst material (also referred to herein simply as “catalyst material”) and HT-PEM fuel cells with the catalyst material. The catalyst material includes phosphate-tolerant core-shell nanoparticles and the phosphate-tolerant core-shell nanoparticles include a core, e.g., a palladium (Pd) containing core (Pd-containing core) or a platinum (Pt) containing core (Pt-containing core), a platinum (Pt) containing shell (Pt-containing shell) on the Pd-containing or Pt-containing core, in a compressed state, and an anti-phosphate poisoning surface modifier on the Pt-containing shell. As used herein, the phrases “Pd-containing core” and “Pd alloy core” refer to a core of a core/shell nanoparticle having a chemical composition (in weight percent) with the content of Pd being greater than any other element in the core. Similarly, the phrases “Pt-containing core” and “Pt alloy core” refer to a core of a core/shell nanoparticle having a chemical composition (in weight percent) with the content of Pt being greater than any other element in the core. Also, the phrase “compressed state” refers to the Pt-containing shell having a negative strain.

In some variations, The Pd-containing core or the Pt-containing core has an average diameter between about 3 nanometers (nm) and about 20 nm, and the Pt-containing shell has an average thickness less than about 2 nm and greater than about 0.5 nm. In some variations, the Pt-containing shell had an average thickness less than about 2 nm and greater than about 1.0 nm.

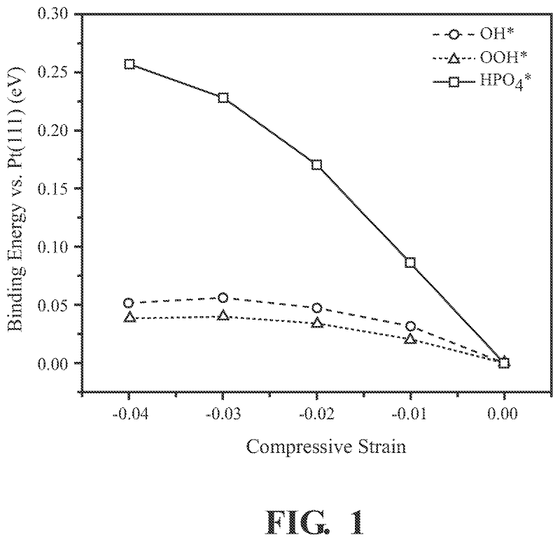

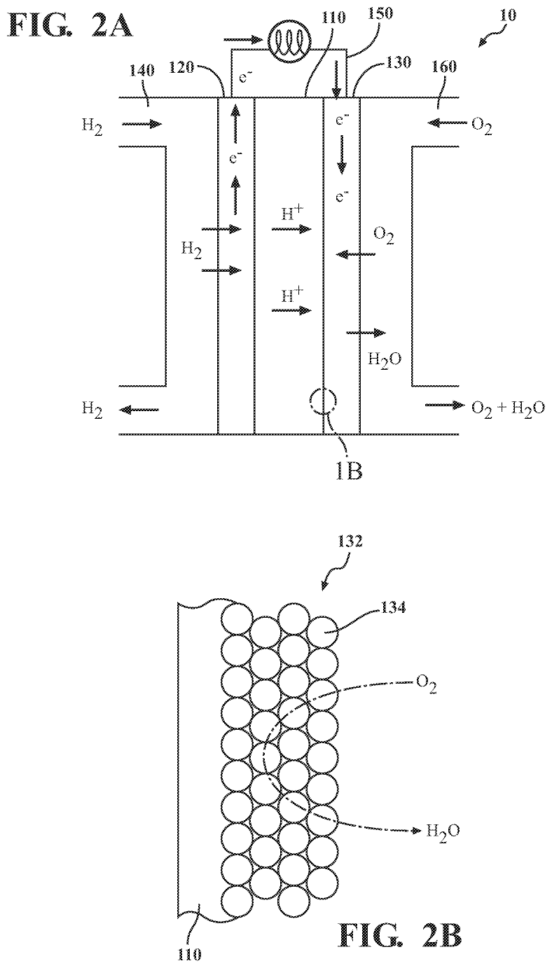

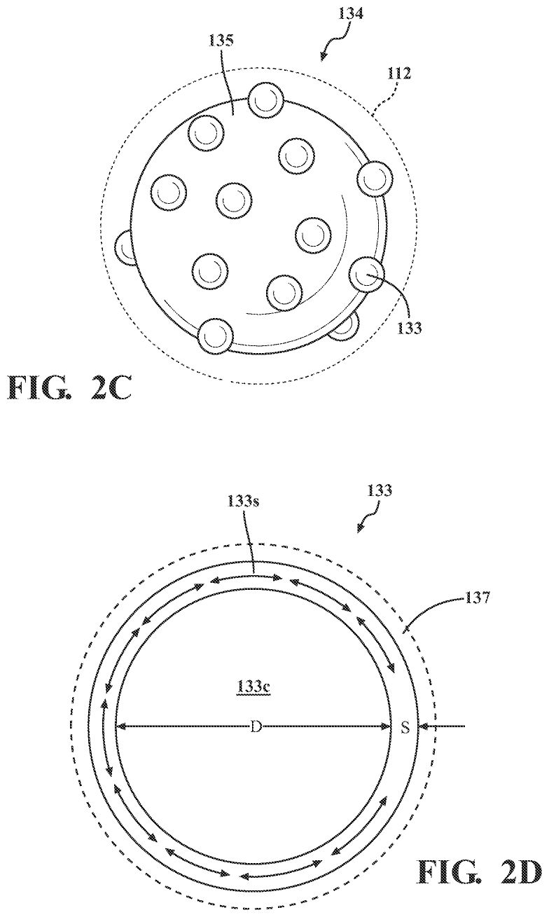

Not being bound by theory, the Pt-containing shell in the compressed state has a weaker binding strength with phosphoric acid, i.e., the OH*, OOH*, and [HPO₄]²⁻ species, compared to a Pt-containing shell not in a compressed state and thus the phosphoric acid adsorption on the catalyst surface (i.e., the Pt-containing shell) is reduced. And such a reduction increases the surface reactive sites on the Pt-containing shell surface and thereby improves the ORR activity in a phosphoric acid electrolyte. For example, and with reference to FIG. 1, a graphical plot of relative binding energy for the species OH*, OOH*, and [HPO₄]²⁻ on a Pt skin/shell as a function of compression strain imposed on the Pt skin/shell is shown. And as observed form FIG. 2, increasing the compression strain of the Pt skin/shell results in a more positive binding energy, and thus weaker adsorption, of the species OH*, OOH*, and HPO₄*. Accordingly, FIG. 1 illustrates that a Pt-containing shell, in the compressed state, has a weaker binding strength with phosphoric acid than a Pt-containing shell now in a compressed state.

Referring now to FIG. 2A, a HT-PEM fuel cell 10 is shown. The HT-PEM fuel cell 10 includes a PEM 110 sandwiched between an anode 120 and a cathode 130, a phosphoric acid electrolyte 112, and an external electrical circuit 150 that electrically connects the anode 120 and the cathode 130. The cathode 130 includes a catalyst layer 132 with a plurality of composite particles 134 as illustrated in FIG. 2B, and the composite particles 134 include a plurality of phosphate-tolerant core-shell nanoparticles 133 supported on carbon particles 135 as illustrated in FIG. 2C (only one carbon particle 135 shown). In the alterative, or in addition to, one of more of the plurality of phosphate-tolerant core-shell nanoparticles 133 can be disposed within pores (not shown) of the carbon particle 135.

During operation of the HT-PEM fuel cell 10, hydrogen (H₂) gas is provided to and flows through an anode-side inlet 140 and oxygen (O₂) gas (e.g., O₂ in air) is provided to and flows through a cathode-side inlet 160. At least a portion of the H₂ flows into contact with the anode 120 and migrates to the PEM 110 where H₂ molecules are catalyzed into H⁺ ions plus electrons ‘e⁻’ (e.g., via an anode catalyst layer—not shown). Also, at least a portion of the O₂ gas flows into contact with the cathode and migrates to the PEM 110. The electrons e⁻ flow through the external electrical circuit 150 to the cathode 130 and react with O₂ molecules to form O₂-ions (e.g., via the catalyst layer 132) and the H⁺ ions diffuse through the PEM 110 to the cathode 130 and react with the O₂-ions to form H₂O (water), which is then transported out of the HT-PEM fuel cell 10 with the flow of unreacted O₂. In this manner, the phosphate-tolerant core-shell nanoparticles 133 assist in and enhance the reaction of O₂+e⁻ to O²⁻ and/or O²⁻+H⁺ to H₂O and electricity is generated by the HT-PEM fuel cell 10.

Referring specifically to FIG. 2C, in some variations the phosphoric acid electrolyte 112 is in contact with and at least partially surrounds the composite particles 134. And in such variations, the phosphate ions from the phosphoric acid electrolyte 112 can poison the plurality of phosphate-tolerant core-shell nanoparticles 133 (also known as “phosphate poisoning”) such that the efficiency of the catalyst layer 132 decreases. However, and as illustrated in FIG. 2D, the plurality of phosphate-tolerant core-shell nanoparticles 133 include a core 133c with a diameter ‘D’, a Pt-containing shell 133s with a thickness ‘t’ and in a compressed state, and an anti-phosphate poisoning surface modifier 137. The Pt-containing shell 133s in the compressed state enhances the catalytic activity of the phosphate-tolerant core-shell nanoparticles 133 as discussed in greater detail below, and the anti-phosphate poisoning surface modifier 137 reduces phosphate poisoning of the Pt-containing shell 133s as also discussed in greater detail below.

In some variations, the core 133c is a Pd-containing core 133c, e.g., a Pd alloy core formed from a PdM₁ alloy where M₁ is one or more of Pt, Fe, Co, and Ni. For example, in at least one variation the PdM₁ alloy is a Pd—Pt alloy, a Pd—Fe alloy, a Pd—Pt—Fe alloy, a Pd—Co alloy, a Pd—Pt—Co alloy, a Pd—Ni alloy, or a Pd—Pt—Ni alloy, a Pd—Cu alloy, or a Pd—Pt—Cu alloy.

In other variations, the core 133c is a Pt-containing core 133c, e.g., a Pt alloy core formed from a PtM₁ alloy where M₁ is one or more of Pd, Fe, Co, and Ni. For example, in at least one variation the PdM₁ alloy is a Pt—Fe alloy, a Pt—Pd—Fe alloy a Pt—Co alloy, a Pt—Pd—Co alloy, a Pt—Ni alloy, a Pt—Pd—Ni alloy, a Pt—Cu alloy, or a Pt—Pd—Cu alloy.

Similarly, in some variations the Pt-containing shell 133s is a Pt alloy shell, i.e., a shell formed from a PtM₂ alloy where M₂ is gold (Au) or silver (Ag). However, in all variations the 133c and the Pt-containing shell 133s are alloyed such that the Pt-containing shell 133s is in a compressed state.

For example, Pd is reported to have an atomic radius of 131 picometers (pm), Pt has an atomic radius of 128, Fe has an atomic radius of 125 pm, Co has an atomic radius of 126 μm, and Ni has an atomic radius of 121 pm. Accordingly, alloying Pd with Pt, Fe, Co, and/or Ni results in an alloy with an average atomic radius between 131 μm and 121 μm. In contrast, Au has an atomic radius of 144 μm and silver has an atomic radius of 153 μm, and thus Pt can be alloyed with Au and/or Ag to provide a PtM₂ alloy with an average atomic radius significantly greater than 131 pm. Stated differently, the Pt-containing shell 133s has a larger average atomic radius than the Pd-containing core 133c or the Pt-containing core 133c such that forming Pt-containing shell 133s with the larger average atomic radius onto the core 133c with the smaller average atomic radius results in the Pt-containing shell 133s being in a compressed state as illustrated by the double-headed arrows in FIG. 2D. Stated differently, with the Pt-containing shell 133s having a larger lattice than the core 133c, the Pt-containing shell 133s on the core 133c experiences or has a compressive strain.

In addition to the Pt-containing shell 133s in the compressed state, and as noted above, the phosphate-tolerant core-shell nanoparticles 133 also include the anti-phosphate poisoning surface modifier 137. In some variations, the anti-phosphate poisoning surface modifier 137 is one or more of melamine, poly(melamine-co-formaldehyde), and tetra(tert-butyl)-tetraazaporphyrin.

In order to illustrate the enhanced catalytic activity of the phosphate-tolerant core-shell catalyst nanoparticles according to the present disclosure, results from testing the phosphate-tolerant core-shell catalyst nanoparticles in both perchloric acid (HClO₄) and perchloric acid plus phosphoric acid (H₃PO₄) environments are provided and discussed below.

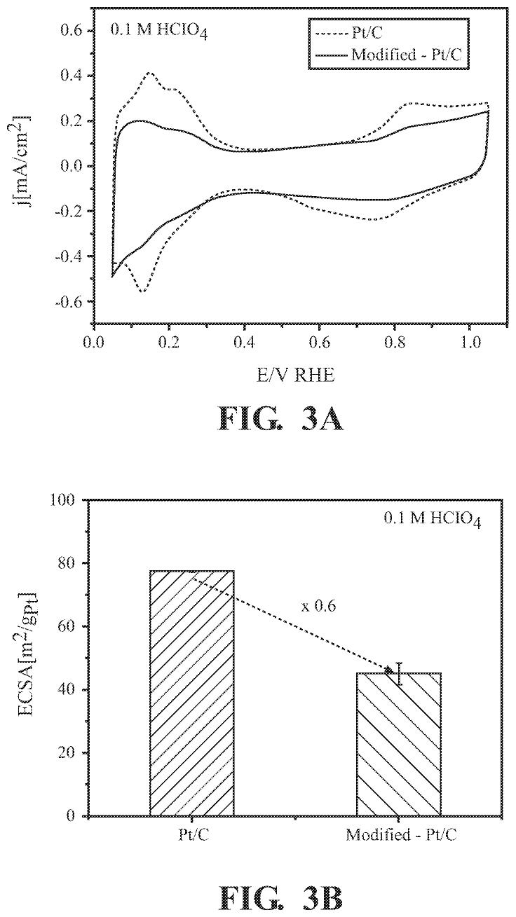

Referring to FIGS. 3A-3B, results of cyclic voltammetry testing of Pt nanoparticles according to the teachings of the present disclosure, with and without an anti-phosphate poisoning surface modifier, in a 0.1 M HClO₄ aqueous solution are shown in FIG. 3A and the electrochemical surface area (ECSA) of the Pt nanoparticles, with and without the anti-phosphate poisoning surface modifier is shown in FIG. 3A. And while testing results are shown for Pt nanoparticles, and illustrated by the data shown in FIG. 1, it is expected that core-shell nanoparticles as disclosed herein would provide superior results that provided and discussed below for Pt nanoparticles. As used herein, the phrase “electrochemical surface area” refers to the area of the Pt/C nanoparticle surface that was accessible to the 0.1 M HClO₄ aqueous solution.

Still referring to FIGS. 3A-3B the Pt nanoparticles were on a carbon support (referred to herein as “Pt/C nanoparticles”) and the anti-phosphate poisoning surface modifier was in the form of poly(melamine-co-formaldehyde) (PMF). And as observed in FIG. 3B, the decrease in ECSA of the Pt/C nanoparticles with the anti-phosphate poisoning surface modifier demonstrated successful modification of the Pt surface. Stated differently, PMF modification of the Pt surface decreases the ECSA, including the accessible area for ORR. Yet the ORR activity is higher after modification due to a higher specific activity. A commonly accepted theory for such activity enhancement is that PMF suppresses the adsorption of water molecules on Pt surface, while unmodified Pt that has water adsorption on the surface could stabilize OH* intermediates. A slightly weaker OH* adsorption on Pt can facilitate ORR kinetics. In other words, PMF-modified Pt has more favorable Pt—OH binding, making it more active for ORR. Even the accessible sites decrease, those accessible sites are more active, and so higher mass activity is observed.

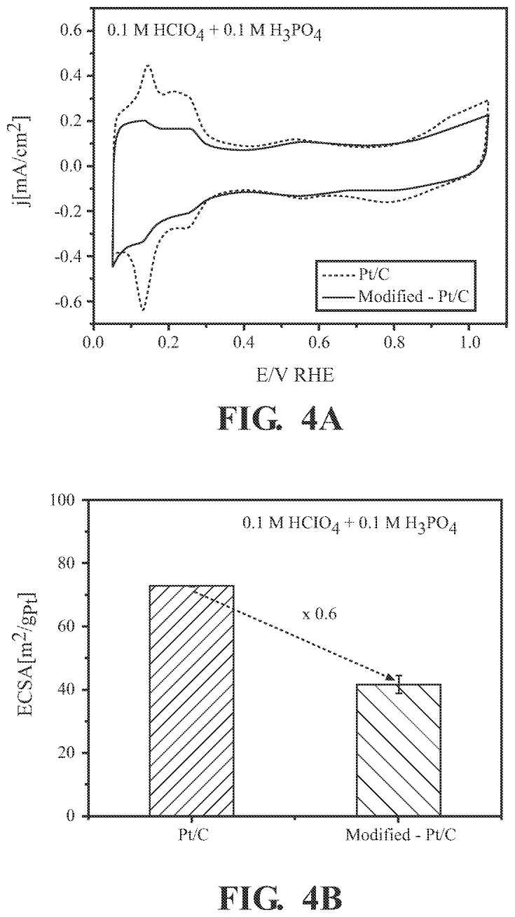

Referring to FIGS. 4A-4B, results of cyclic voltammetry testing of the Pt/C nanoparticles described above, with and without an anti-phosphate poisoning surface modifier, in a 0.1 M HClO₄+0.1 M H₃PO₄ aqueous solution are shown in FIG. 3A and the electrochemical surface area (ECSA) of the Pt/C nanoparticles, with and without the anti-phosphate poisoning surface modifier is shown in FIG. 4B. And similar to the results of the Pt/C nanoparticles in 0.1 M HClO₄, a decrease in ECSA of the Pt/C nanoparticles with the anti-phosphate poisoning surface modifier (FIG. 4B) demonstrates successful modification of the PtAu shell surface with respect to H₃PO₄.

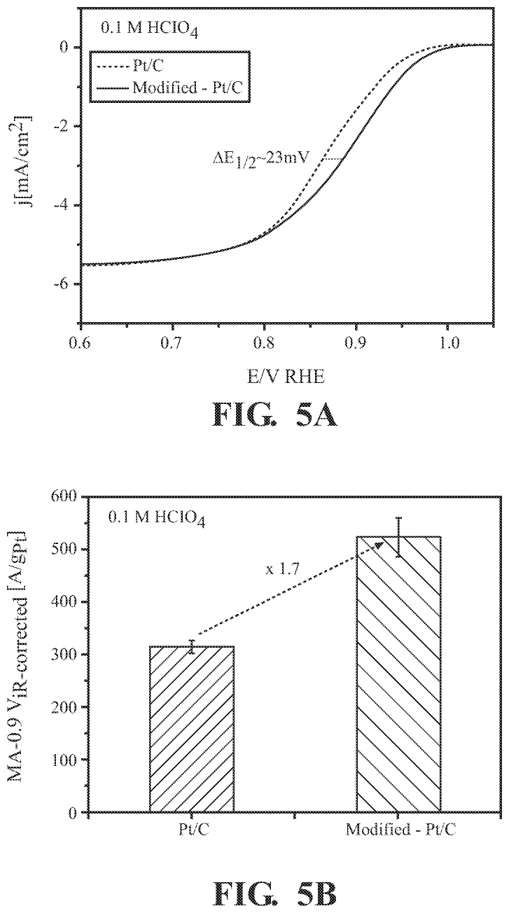

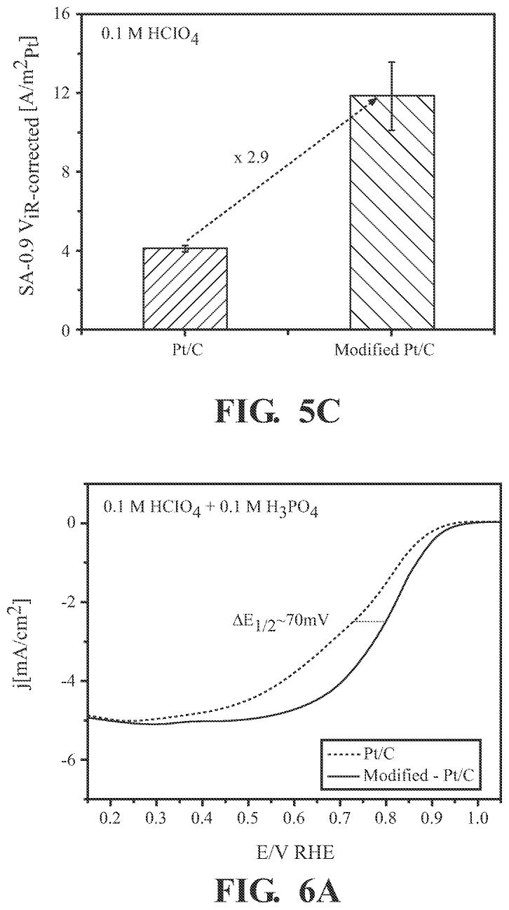

Referring to FIGS. 5A-5C, results of linear scanning voltammetry of Pt/C nanoparticles, with and without an anti-phosphate poisoning surface modifier (PMF), in a 0.1 M HClO₄ aqueous solution are shown in FIG. 5A, and the mass activity (i.e., the oxygen reduction reaction kinetic current in amperes divided by the mass of Pt in grams) of a Pt/C nanoparticles without an anti-phosphate poisoning surface modifier and the Pt/C nanoparticles with an anti-phosphate poisoning surface modifier in 0.1 M HClO₄ is shown in FIG. 5B. And specific activity (i.e., the oxygen reduction reaction kinetic current in amperes divided by the electrochemical surface area in centimeters squared) of the Pt/C nanoparticles without an anti-phosphate poisoning surface modifier and the Pt/C nanoparticles with an anti-phosphate poisoning surface modifier in 0.1 M HClO₄ is shown in FIG. 5C.

As observed in FIGS. 4B, the decrease in ECSA of the Pt/C nanoparticles with the anti-phosphate poisoning surface modifier demonstrates successful modification of the Pt surface. And treatment of the Pt/C nanoparticles with PMF effectively increased the mass activity and specific activity of the Pt/C nanoparticles with respect to 0.1 M HClO₄. In fact, the Pt/C nanoparticles with PMF exhibited a 1.7 times increase in mass activity and a 2.9 times increase in specific activity compared to the Pt/C nanoparticles without an anti-phosphate poisoning surface modifier.

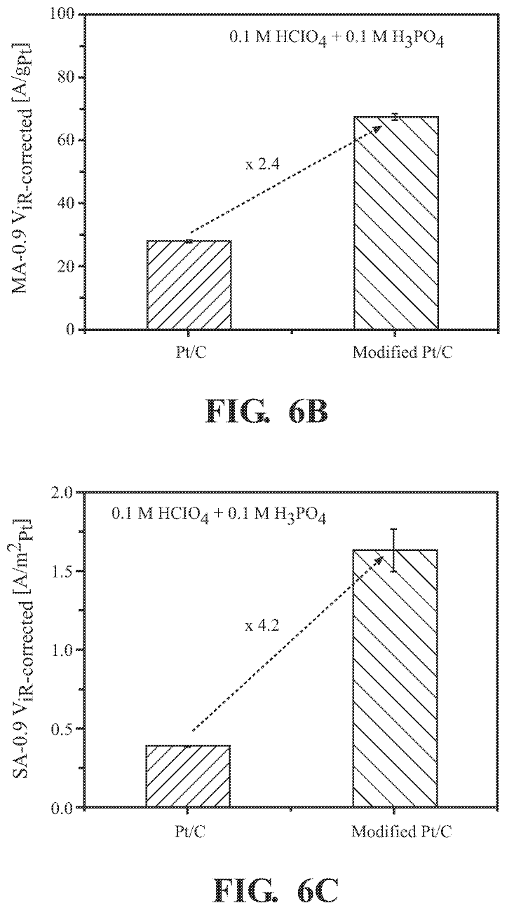

Referring to FIGS. 6A-6C, results of linear scanning voltammetry of Pt/C nanoparticles, with and without an anti-phosphate poisoning surface modifier (PMF), in a 0.1 M HClO₄+0.1 M H₃PO₄ aqueous solution are shown in FIG. 6A, and the mass activity of the Pt/C nanoparticles without an anti-phosphate poisoning surface modifier and the Pt/C nanoparticles with an anti-phosphate poisoning surface modifier in 0.1 M HClO₄+0.1 M H₃PO₄ is shown in FIG. 6B. And the specific activity of the Pt/C nanoparticles without an anti-phosphate poisoning surface modifier and the Pt/C nanoparticles with an anti-phosphate poisoning surface modifier in 0.1 M HClO₄+0.1 M H₃PO₄ is shown in FIG. 6C.

Stated differently, treatment of the Pt/C nanoparticles with PMF effectively increased the mass activity and specific activity of the Pt/C nanoparticles with respect to 0.1 M HClO₄+0.1 M H₃PO₄. In fact, the Pt/C nanoparticles with PMF exhibited a 2.4 times increase in mass activity and a 4.2 times increase in specific activity in 0.1 M HClO₄+0.1 M H₃PO₄ compared to the Pt/C nanoparticles without an anti-phosphate poisoning surface modifier. Stated differently, the Pt/C nanoparticles with PMF exhibited a decrease in surface area that was accessibly to phosphate ions and thus an increase in surface area available for the ORR.

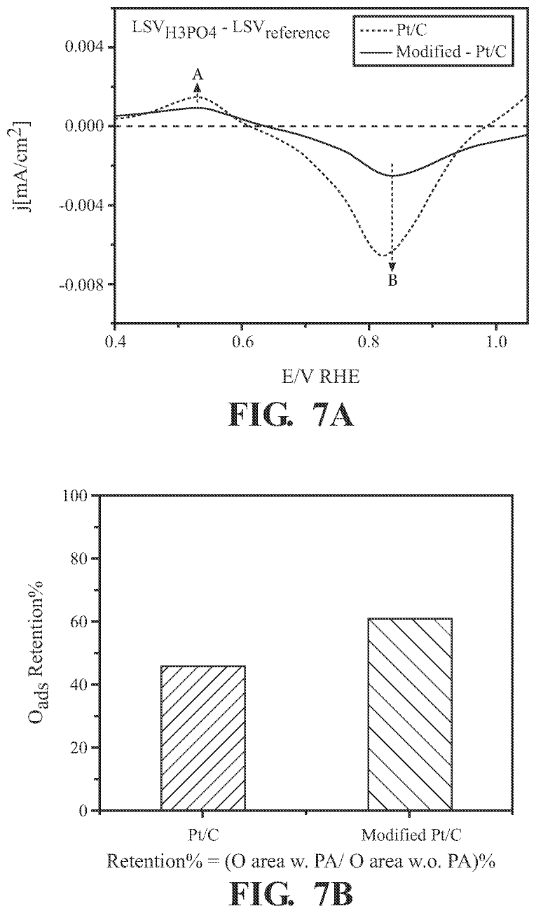

Referring now to FIG. 7A, the difference of linear scanning voltammetry in the 0.1 M HClO₄+0.1 M H₃PO₄ aqueous solution and the 0.1 M HClO₄ reference aqueous solution (LSV-LSVreference) for the Pt/C nanoparticles, with and without the anti-phosphate poisoning surface modifier (PMF) is shown in FIG. 7A. In addition, the peaks labeled ‘A’ and ‘B’ in FIG. 7A illustrate the increased phosphate anion adsorption (A) and decreased OH adsorption (B) for the Pt/C nanoparticles without the anti-phosphate poisoning surface modifier compared to the Pt/C nanoparticles with the anti-phosphate poisoning surface modifier. And with reference to FIG. 7B, the percentage oxygen (O) retention on the surface of the Pt/C nanoparticles, with and without the anti-phosphate poisoning surface modifier, is shown, and where the % O adsorption is defined as the area that O can adsorb when it is with phosphoric acid divided by the area that O can adsorb without phosphoric acid. Stated differently, the Pt/C nanoparticles with PMF exhibited a decrease in surface area that was accessibly to phosphate ions and an increase in surface area available for the ORR.

As observed from FIG. 7B, the surface of Pt/C nanoparticles with the anti-phosphate poisoning surface modifier exhibited an oxygen O retention of about 60% compared to a retention of about 47% for the surface of Pt/C nanoparticles without the anti-phosphate poisoning surface modifier. Accordingly, FIGS. 7A-7B exhibit evidence for the enhanced resistance to phosphate poisoning and the ORR improvement by the surface of nanoparticles with a Pt-containing shell, in a compressed state, and with the anti-phosphate poisoning surface modifier. Particularly, and not being bound by theory, adding H₃PO₄ to the HClO₄ solution results phosphate anions adsorbing onto the Pt surface such that the bare Pt/C nanoparticles (dashed line) show a positive peak at about 0.5 V in FIG. 7A. Also, the phosphate anion adsorption suppressed the oxide formation on the Pt surface, thereby leading to a decrease of the current under the potential range where oxide typically form (0.7-1.0 V, FIG. 7A). In contrast, the modified-Pt/C nanoparticles exhibited a smaller peak at the phosphate anion adsorption potential of about 0.5 V (solid line), thereby indicating less phosphate anion adsorption on the Pt surface. And while OH-adsorption is also suppressed on the modified-Pt/C surface (a negative peak in FIG. 7A), the suppression is less than that on the Pt/C surface.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A high temperature fuel cell comprising:
an anode, a cathode, a polymer electrolyte membrane disposed between the anode and the cathode;
phosphoric acid; and
a cathode catalyst disposed on the cathode and in contact with the phosphoric acid, the cathode catalyst comprising a plurality of core/shell nanoparticles with:
a core comprising Pd-containing core or a Pt-containing core;
a Pt-containing shell, in a compressed state, on the core; and
an anti-phosphate poisoning surface modifier disposed on the Pt-containing shell.

2. The high temperature fuel cell according to claim 1, wherein the core is the Pd-containing core comprising a Pd alloy core selected from the group consisting of a Pd—Fe alloy, a Pd—Pt—Fe alloy, a Pd—Co alloy, a Pd—Pt—Co alloy, a Pd—Ni alloy, or a Pd—Pt—Ni alloy, a Pd—Cu alloy, and a Pd—Pt—Cu alloy.

3. The high temperature fuel cell according to claim 1, wherein the core is the Pt-containing core comprising a Pt alloy core selected from the group consisting of a Pt—Fe alloy, a Pt—Pd—Fe alloy a Pt—Co alloy, a Pt—Pd—Co alloy, a Pt—Ni alloy, a Pt—Pd—Ni alloy, a Pt—Cu alloy, and a Pt—Pd—Cu alloy.

4. The high temperature fuel cell according to claim 1, wherein the Pt-containing shell is selected from the group consisting a Pt—Au shell and a Pt—Ag shell.

5. The high temperature fuel cell according to claim 1, wherein the anti-phosphate poisoning surface modifier is selected from the group consisting of melamine, poly(melamine-co-formaldehyde), tetra(tert-butyl)-tetraazaporphyrin, and combinations thereof.

6. The high temperature fuel cell according to claim 1, wherein the Pd-containing core has a diameter between about 3 nm and about 20 nm and the Pt-containing shell has a thickness less than about 2 nm.

7. The high temperature fuel cell according to claim 1, wherein:
the core is the Pd-containing core is selected from the group consisting of a Pd—Fe alloy, Pd—Pt—Fe alloy, a Pd—Co alloy, a Pd—Pt—Co alloy, a Pd—Ni alloy, a Pd—Pt—Ni alloy, a Pd—Cu alloy, and a Pd—Pt—Cu alloy;
the Pt-containing shell is selected from the group consisting a Pt—Au shell and a Pt—Ag shell; and
the anti-phosphate poisoning surface modifier is selected from the group consisting of melamine, poly(melamine-co-formaldehyde), tetra(tert-butyl)-tetraazaporphyrin, and combinations thereof.

8. The high temperature fuel cell according to claim 1, wherein:
the core is the Pt-containing core is selected from the group consisting of a Pt—Fe alloy, Pt—Pd—Fe alloy, a Pt—Co alloy, a Pt—Pd—Co alloy, a Pt—Ni alloy, a Pt—Pd—Ni alloy, a Pt—Cu alloy, and a Pt—Pd—Cu alloy;
the Pt-containing shell is selected from the group consisting a Pt—Au shell and a Pt—Ag shell; and
the anti-phosphate poisoning surface modifier is selected from the group consisting of melamine, poly(melamine-co-formaldehyde), tetra(tert-butyl)-tetraazaporphyrin, and combinations thereof.

9. The high temperature fuel cell according to claim 1, wherein:
the core is the Pd-containing core with a diameter between about 3 nm and about 20 nm and selected from the group consisting of a Pd—Fe alloy, Pd—Pt—Fe alloy, a Pd—Co alloy, a Pd—Pt—Co alloy, a Pd—Ni alloy, a Pd—Pt—Ni alloy, a Pd—Cu alloy, and a Pd—Pt—Cu alloy;
the Pt-containing shell has a thickness less than about 2 nm and is selected from the group consisting a Pt—Au shell and a Pt—Ag shell; and
the anti-phosphate poisoning surface modifier is selected from the group consisting of melamine, poly(melamine-co-formaldehyde), tetra(tert-butyl)-tetraazaporphyrin, and combinations thereof.

10. The high temperature fuel cell according to claim 1, wherein:
the core is the Pt-containing core with a diameter between about 3 nm and about 20 nm and selected from the group consisting of a Pt—Fe alloy, Pt—Pd—Fe alloy, a Pt—Co alloy, a Pt—Pd—Co alloy, a Pt—Ni alloy, a Pt—Pd—Ni alloy, a Pt—Cu alloy, and a Pt—Pd—Cu alloy;
the Pt-containing shell has a thickness less than about 2 nm and is selected from the group consisting a Pt—Au shell and a Pt—Ag shell; and
the anti-phosphate poisoning surface modifier is selected from the group consisting of melamine, poly(melamine-co-formaldehyde), tetra(tert-butyl)-tetraazaporphyrin, and combinations thereof.

11. A high temperature fuel cell comprising:
an anode, a cathode, and a polymer electrolyte membrane disposed between the anode and the cathode;
phosphoric acid; and
a cathode nanoparticle catalyst disposed on the cathode and in contact with the phosphoric acid, the cathode nanoparticle catalyst comprising a plurality of nanoparticles with:
a Pd alloy core;
a Pt alloy shell, in a compressed state, on the Pd alloy core; and
an anti-phosphate poisoning surface modifier disposed on the Pt alloy shell.

12. The high temperature fuel cell according to claim 11, wherein the Pd alloy core has a diameter between about 3 nm and about 20 nm and the Pt alloy shell has a thickness less than about 2 nm.

13. The high temperature fuel cell according to claim 12, wherein the Pd alloy core is selected from the group consisting of a Pd—Fe alloy core, Pd—Pt—Fe alloy core, a Pd—Co alloy core, a Pd—Pt—Co alloy core, a Pd—Ni alloy core, a Pd—Pt—Ni alloy core, a Pd—Cu alloy core, and a Pd—Pt—Cu alloy core.

14. The high temperature fuel cell according to claim 13, wherein the Pt alloy shell is selected from the group consisting a Pt—Au shell and a Pt—Ag shell.

15. The high temperature fuel cell according to claim 14, wherein, the anti-phosphate poisoning surface modifier is selected from the group consisting of melamine, poly(melamine-co-formaldehyde), tetra(tert-butyl)-tetraazaporphyrin, and combinations thereof.

16. The high temperature fuel cell according to claim 11, wherein:
the Pd alloy core has a diameter between about 3 nm and about 20 nm and the Pt alloy shell has a thickness less than about 2 nm;
the Pd alloy core is selected from the group consisting of a Pd—Fe alloy core, Pd—Pt—Fe alloy core, a Pd—Co alloy core, a Pd—Pt—Co alloy core, a Pd—Ni alloy core, a Pd—Pt—Ni alloy core, a Pd—Cu alloy core, and a Pd—Pt—Cu alloy core;
the Pt alloy shell is selected from the group consisting a Pt—Au shell and a Pt—Ag shell; and
the anti-phosphate poisoning surface modifier is selected from the group consisting of melamine, poly(melamine-co-formaldehyde), tetra(tert-butyl)-tetraazaporphyrin, and combinations thereof.

17. A high temperature fuel cell comprising:
an anode, a cathode, and a polymer electrolyte membrane disposed between the anode and the cathode;
phosphoric acid; and
a cathode nanoparticle catalyst disposed on the cathode and in contact with the phosphoric acid, the cathode nanoparticle catalyst comprising a plurality of nanoparticles with:
a Pt alloy core with a diameter between about 3 nm and about 20 nm;
a Pt alloy shell, in a compressed state, with a thickness less than about 2 nm on the Pt alloy core; and
an anti-phosphate poisoning surface modifier disposed on the Pt alloy shell.

18. The high temperature fuel cell according to claim 17, wherein the Pt alloy core is selected from the group consisting of a Pt—Fe alloy core, Pt—Pd—Fe alloy core, a Pt—Co alloy core, a Pt—Pd—Co alloy core, a Pt—Ni alloy core, a Pt—Pd—Ni alloy core, a Pt—Cu alloy core, and a Pt—Pd—Cu alloy core.

19. The high temperature fuel cell according to claim 18, wherein the Pt alloy shell is selected from the group consisting a Pt—Au shell and a Pt—Ag shell.

20. The high temperature fuel cell according to claim 19, wherein, the anti-phosphate poisoning surface modifier is selected from the group consisting of melamine, poly(melamine-co-formaldehyde), tetra(tert-butyl)-tetraazaporphyrin, and combinations thereof.
